(19) United States
(12) Patent Application Publication
(10) Pub. No.: US 2024/0430764 A1
(43) Pub. Date: Dec. 26, 2024

(54) HANDLING SERVING CELL SELECTION WHEN SIGNAL ATTENUATION IS HIGH

(71) Applicant: SAMSUNG ELECTRONICS CO., LTD., Suwon-si (KR)

(72) Inventors: Venkata Ratnakar Rao RAYAVARAPU, Bangalore (IN); Jajohn MATHEW MATTAM, Bangalore (IN); Dibyajyoti PATI, Bangalore (IN)

(73) Assignee: SAMSUNG ELECTRONICS CO., LTD., Suwon-si (KR)

(21) Appl. No.: 18/751,981

(22) Filed: Jun. 24, 2024

(30) Foreign Application Priority Data
Jun. 26, 2023 (IN) 202341042762
Feb. 29, 2024 (IN) 202341042762

(51) Int. Cl. H04W 36/06; H04B 17/318; H04W 36/00

(52) U.S. Cl. CPC H04W 36/06; H04B 17/328; H04W 36/0058; H04W 36/00837

(57) ABSTRACT

According to an aspect of the disclosure, a user equipment (UE) in a wireless network is provided. The UE comprises a processor; and a memory storing instructions that, when executed by the processor, cause the UE to determine whether a trigger condition is detected or not; based on the trigger condition being not detected, select a cell among a plurality of cells for the UE in accordance with a signal quality; based on the trigger condition being detected, select a cell from at least one cell of low-band frequency category, the plurality of cells categorized into the low-band frequency category, a mid-band frequency category, and high-band frequency category; and camp to the cell or transmit, on a serving cell, a measurement report including a measurement result of the cell.

### CROSS-REFERENCE TO RELATED APPLICATIONS

This application is based on and claims priority under 35 U.S.C. § 119 to Indian Provisional Application No. 20/2341042762, filed on Jun. 26, 2023, in the Indian Patent Office, and to Indian Complete application No. 202341042762, filed on Feb. 29, 2024, in the Indian Patent Office, the disclosures of each of which are incorporated by reference herein in their entireties.

### BACKGROUND

### 1. Field

The disclosure relates to a wireless network. More particularly, the disclosure relates to handling serving cell selection when signal attenuation is high in a wireless network.

### 2. Description of Related Art

Attenuation, measured in decibels (dB), refers to the loss of electronic signal strength during transmission. For example, as a User Equipment (UE) moves around a building corner, signals transmitted from a base station may become distorted due to increased attenuation. Wireless signals can be attenuated by noise, physical obstacles, and long distances, resulting in reduced signal transmission. External sources of noise at frequencies that penetrate the signal carried by the cable can affect attenuation rates in cabling. Additionally, signal attenuation increases with higher frequencies, as wavelength decreases. The material through which the signal may travel also affects attenuation, with higher attenuation indicating higher path loss that can impact UE performance, particularly in the Uplink (UL). Therefore, considering cell attenuation when selecting the most suitable cell in a location is essential for improving UE performance.

Frequency bands are broadly classified into low, mid, and high bands. Low band frequencies offer extensive coverage capabilities, making them ideal for long-distance communication and reaching rural or hard-to-access areas. However, low band frequencies lack the speed and capacity characteristics of higher bands, resulting in performance similar to Fourth Generation (4G) Long Term Evolution (LTE) for low-band Fifth Generation (5G).

Mid-band frequencies strike a balance between a speed, a bandwidth, and a coverage, making them well-suited for servicing small cities, towns, and suburban areas. Mid-band 5G offers superior speed and capacity compared to low-band 5G while extending coverage over greater distances than high-band 5G.

High-band frequencies, also known as millimeter wave (mmWave), provide exceptionally rapid speed and tremendous bandwidth. However, the high-energy waves travel shorter distances, making them ideal for dense urban settings or high-traffic venues. Due to the abundance of high band spectrum available, mmWave offers breathtaking performance capabilities.

In conventional methods of a cell selection during idle mode, the UE typically selects the best available cells based solely on signal strength, without considering frequency or bandwidth factors. Similarly, during a cell reselection in the inactive mode or while connected, the UE waits for the serving cell criteria to fall below the configured threshold in terms of received signal strength, ultimately choosing the best neighboring cell regardless of frequency or bandwidth considerations. Additionally, during the handover process within the connected mode, the UE follows a similar procedure, waiting for the serving cell criteria to fall below the configured threshold and reporting the neighbor cell that meets the criteria, without taking frequency or bandwidth parameters into account. However, when the UE is in a higher bandwidth or frequency, it may monitor resources across the entire bandwidth, leading to increased power consumption.

In certain cases, the UE's normal operations do not necessarily require higher frequency bands. However, there may be instances where the UE requires broader coverage and long-distance communication frequency bands (lower bands) due to increased attenuation in higher frequency bands. This can result in higher power consumption and reduced Quality of Service (QOS) when the UE operates in higher frequency bands with high attenuation, particularly when such bands are unnecessary for normal UE operations.

Thus, it is desired to address the above-mentioned disadvantages or other shortcomings or at least provide a useful alternative to overcome the inter-device connection setup problems and synchronization problems.

### SUMMARY

Provided is a UE and a method for handling serving cell selection when signal attenuation is high in a wireless network. In the disclosure, the UE prioritizes the cell with the lowest available frequency during cell selection or reselection, either when signal attenuation is high or when a trigger condition is satisfied.

Provided is to circumvent the need for measuring cells in higher frequency bands, when the signal state of cells in lower frequency bands has been deactivated during the process of cell reselection.

Provided is to circumvent the need for measuring the higher frequency band cell, except in cases where the signal quality of the lower frequency band cells deteriorates or a service requiring higher data rates is initiated in connected mode.

Provided is to report UE Assistance Information (UAI) to the network, indicating the absence of Carrier Aggression (CA) when the UE initiates the removal of higher frequency band measurements.

According to an aspect of the disclosure, a method for handling serving a cell selection or a reselection for a User Equipment (UE) in a wireless network, includes: detecting, by the UE, a trigger condition to initiate the cell selection or the reselection or sending a measurement report, wherein the trigger condition indicates that the UE is in one of an idle mode, a connected mode, and an inactive mode; determining, by the UE, a plurality of cells belonging to a predefined range of a band frequency for camping the UE; and based on the trigger condition, camping, by the UE, to at least one cell from the plurality of cells belonging to a predefined lowest band frequency.

According to an aspect of the disclosure, an User Equipment (UE) for handling serving a cell selection or a reselection in a wireless network, includes: a memory; a communication processor; an input/output (I/O) interface; and a cell selection controller communicatively coupled to the memory, the communication processor and the I/O interface, wherein the cell selection controller is configured to: detect a trigger condition to initiate the cell selection or reselection or sending measurement report, wherein the trigger condition indicates that the UE is in one of an idle mode, a connected mode, and an inactive mode; determine a plurality of cells belonging to a predefined range of band frequency for camping the UE; and camp to at least one cell from the plurality of cells belonging to a predefined lowest band frequency based on the trigger condition.

According to an aspect of the disclosure, a method performed by a user equipment (UE) in a wireless network is provided. The method comprises determining whether a trigger condition is detected or not; based on the trigger condition being not detected, selecting a cell among a plurality of cells for the UE in accordance with a signal quality; based on the trigger condition being detected, selecting a cell from at least one cell of low-band frequency category, the plurality of cells categorized into the low-band frequency category, a mid-band frequency category, and high-band frequency category; and camping to the cell or transmitting, on a serving cell, a measurement report including a measurement result of the cell.

According to an aspect of the disclosure, a user equipment (UE) in a wireless network is provided. The UE comprises a processor; and a memory storing instructions that, when executed by the processor, cause the UE to determine whether a trigger condition is detected or not; based on the trigger condition being not detected, select a cell among a plurality of cells for the UE in accordance with a signal quality; based on the trigger condition being detected, select a cell from at least one cell of low-band frequency category, the plurality of cells categorized into the low-band frequency category, a mid-band frequency category, and high-band frequency category; and camp to the cell or transmit, on a serving cell, a measurement report including a measurement result of the cell.

According to an aspect of the disclosure, a non-transitory computer readable storage medium is provided. The non-transitory computer readable storage medium stores instructions that, when executed by a processor, cause a user equipment (UE) to perform operations including determining whether a trigger condition is detected or not; based on the trigger condition being not detected, selecting a cell among a plurality of cells for the UE in accordance with a signal quality; based on the trigger condition being detected, selecting a cell from at least one cell of low-band frequency category, the plurality of cells categorized into the low-band frequency category, a mid-band frequency category, and high-band frequency category; and camping to the cell or transmitting, on a serving cell, a measurement report including a measurement result of the cell.

These and other aspects of the disclosure herein will be better appreciated and understood when considered in conjunction with the following description and the accompanying drawings. It is understood, however, that the following descriptions, while indicating preferred embodiments and numerous specific details thereof, are given by way of illustration and not of limitation. Many changes and modifications be made within the scope of the embodiments herein without departing from the spirit thereof, and the disclosure herein include all such modifications.

### BRIEF DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1A is a graphical representation that illustrates the frequency-dependent attenuation of a signal as it passes through different materials, accordingly to the related art;

FIG. 1B is an example diagram that distinguishes between low band, mid band and high band frequencies, accordingly to the related art;

FIG. 1C is a schematic diagram that illustrates the path loss of different materials through which the signal traverses, accordingly to the related art;

FIG. 1D is a schematic diagram that illustrates path loss for concrete material through which the signal traverses, for two different cells, accordingly to the related art;

FIG. 1E is a schematic diagram that illustrates a scenario in which the UE selects the cell with better signal strength when the UE is at cell edge of two cells, accordingly to the related art;

FIG. 1F is a flow diagram that illustrates drawbacks of the UE selecting best cell based on signal strength during cell selection or cell reselection, accordingly to the related art;

FIG. 1G is a sequence diagram that illustrates a scenario in which the network configures the pruned higher bands cells as secondary cells in connected mode, accordingly to the related art;

FIG. 1H is a sequence diagram that illustrates a scenario in which the UE selects the best cell based on Reference Signal Received Power (RSRP) during cell selection or cell reselection in connected mode, accordingly to the related art;

FIG. 2 is a block diagram of the UE for handling serving cell selection when the signal attenuation is high in a wireless network, accordingly to embodiments as disclosed herein;

FIG. 3A depicts a scenario in which the UE is located within an overlapping region of cells operating in the low, mid, and high frequency bands, accordingly to the embodiments as disclosed herein;

FIG. 3B depicts a scenario in which the UE transitions from a low band cell to a mid-band cell, accordingly to the embodiments as disclosed herein;

FIG. 3C depicts a scenario in which the UE prioritizes the low band cell over the mid band cell, accordingly to the embodiments as disclosed herein;

FIG. 4 is a sequence diagram that illustrates a scenario attenuation is detected based on the received Reference Signal Received Power (RSRP) at the UE, accordingly to the embodiments as disclosed herein;

FIG. 5A is a sequence diagram that illustrates a scenario in which the UE prioritizes the lower band cells upon meeting a trigger condition, accordingly to the embodiments as disclosed herein;

FIG. 5B is a flow diagram that illustrates the prioritization of lower band cells by the UE during idle mode, inactive mode, and connected mode, accordingly to the embodiments as disclosed herein;

FIG. 6A is a sequence diagram that illustrates a scenario in which the UE prioritizes the lower band cells while selecting cell in the idle mode, accordingly to the embodiments as disclosed herein;

FIG. 6B is a flow diagram that illustrates the prioritization of lower band cells by the UE, in the event that a band priority has been established, accordingly to the embodiments as disclosed herein;

FIG. 7A is a sequence diagram that illustrates a scenario of the UE prioritizes the lower band cells while performing cell reselection in the idle/inactive mode, accordingly to the embodiments as disclosed herein;

FIG. 7B is a sequence diagram that illustrates a scenario in which the UE prioritizes cells in the lower band during cell reselection in the idle/inactive mode. This prioritization is based on predefined thresholds, accordingly to the embodiments as disclosed herein;

FIG. 8A is a sequence diagram that illustrates a scenario in which the UE prioritizes the lower band cells in the connected mode, accordingly to the embodiments as disclosed herein;

FIG. 8B is a sequence diagram that illustrates a scenario in which the UE prioritizes the lower band cells while in the connected mode, in accordance with the predefined thresholds, accordingly to the embodiments as disclosed herein;

FIG. 8C is a flow diagram that illustrates the UE's ability to halt the pruning of higher bands for measurements in the connected state, in response to a need for increased bandwidth to support ongoing services, accordingly to the embodiments as disclosed herein;

FIG. 9A is a sequence diagram that illustrates a scenario in which the UE reports a UAI to the network in the connected mode, accordingly to the embodiments as disclosed herein;

FIG. 9B is a sequence diagram that illustrates a scenario in which the UE reports the UAI to the network during pruning and non-pruning of the measurements, accordingly to the embodiments as disclosed herein;

FIG. 10A is a schematic diagram that illustrates the material in which the UE is situated, accordingly to the embodiments as disclosed herein;

FIG. 10B is a schematic diagram that illustrates a method of identifying the material behind which the UE is situated, accordingly to the embodiments as disclosed herein; and

FIG. 11 is a flow chart that illustrates a method of handling serving cell selection when the signal attenuation is high in a wireless network, accordingly to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Embodiments disclosed herein provide a method for handling serving cell selection when signal attenuation is high in a wireless network. The method includes detecting by a UE, a trigger condition to initiate the cell selection or reselection or sending measurement report, wherein the trigger condition indicates the UE is in one of an idle mode, a connected mode, and an inactive mode. The UE determines a plurality of cells belonging to a predefined range of band frequency for camping the UE. Further, the method includes camping by the UE, to at least one cell from the plurality of cells belonging to a predefined lowest band frequency based on the trigger condition.

Embodiments disclosed herein provide the UE for handling serving cell selection when the signal attenuation is high in the wireless network. The UE detects the trigger condition to initiate the cell selection or reselection or sending measurement report, wherein the trigger condition indicates the UE is in one of the idle mode, the connected mode, and the inactive mode. The UE determines the plurality of cells belonging to the predefined range of band frequency for camping the UE. Further, the UE is camped to at least one cell from the plurality of cells belonging to the predefined lowest band frequency based on the trigger condition.

In conventional methods and UE, the UE adjusts the reselection priority or cell reselection signal quality metric associated with a cell based on whether the frequency band supports dual connectivity. Dual connectivity supporting neighbour cells are given priority by taking into account their dual connectivity support. Furthermore, a wireless station transmits an inter-frequency System Information Block (SIB) in the customary method, which includes a second cell reselection priority Information Element (IE) and a second anchor-cell reselection priority IE. The second anchor-cell reselection priority IE contains another reselection priority value of another frequency band for another E-UTRA NR Dual Connectivity (EN-DC) anchor. The use of additional anchor-cell priorities enables EN-DC-capable end devices to consistently connect to an anchor cell, even if a non-anchor cell has a higher conventional priority than the anchor cell.

In conventional methods and UE, the base station produces a System Information Block (SIB) message containing a prioritized sequence for cell selection. Within this sequence, newly established radio standalone time division duplex mid-band cells are granted a higher priority than LTE cells. The base station facilitates LTE coverage both in the uplink and downlink. Similarly, the network sends cell reselection priority values to the UE in conventional methods, with the cell reselection priority values consisting of a primary priority value for the second cell and a secondary priority value for the third cell.

In conventional methods and UE, the neighboring cells identified in the SIB or measurement configuration are pruned once the maximum or designated number of neighboring cells that can be incorporated in the measurement report is reached. For instance, if the UE can report only 32 neighbor cells in a measurement report and the network has configured more than 32 neighbor cells (intra RAT+IRAT), the UE elects to prune the measurements of additional neighbor cells.

The disclosure differs from conventional methods and UE in that it prioritizes lower frequency cells during the cell selection and reselection process, particularly when higher band cells are experiencing high attenuation or other trigger points are detected. This is achieved through the use of established techniques such as UWB, Wi-Fi, and RF sensing to detect signal direction and material, enabling the selection and prioritization of lower band cells when signal attenuation is detected. Multiple trigger points for UE Assistance Information (UAI) based on serving cell measurements are utilized, and a method is employed to decide whether to prune or not prune measurements based on the services and bandwidth requirements. The disclosure ensures that the device always attempts to choose a lower frequency cell based on the service it is using, thereby conserving power. Additionally, it helps to maintain high quality of service by reducing failures in the uplink, minimizing the required transmit power, and reducing lower layer failures.

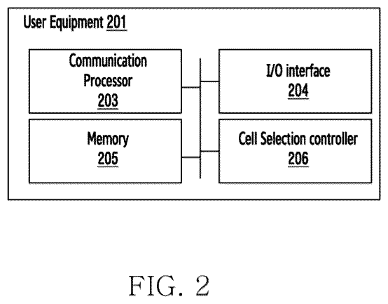

Referring now to the drawings and more particularly to FIGS. 2 through 11, where similar reference characters denote corresponding features consistently throughout the figure, these are shown preferred embodiments.

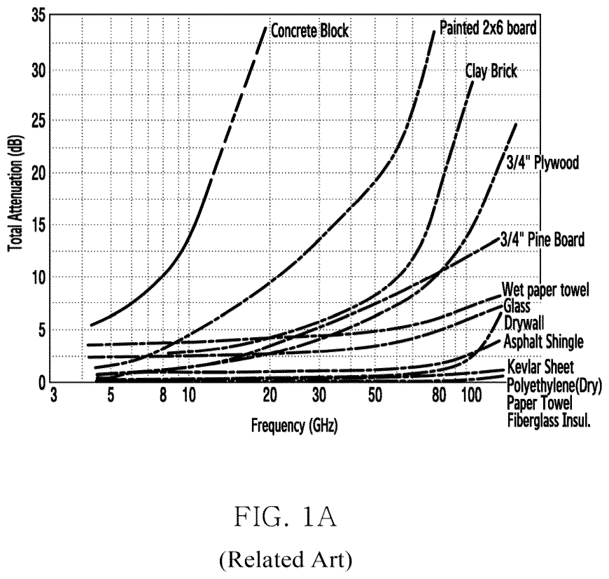

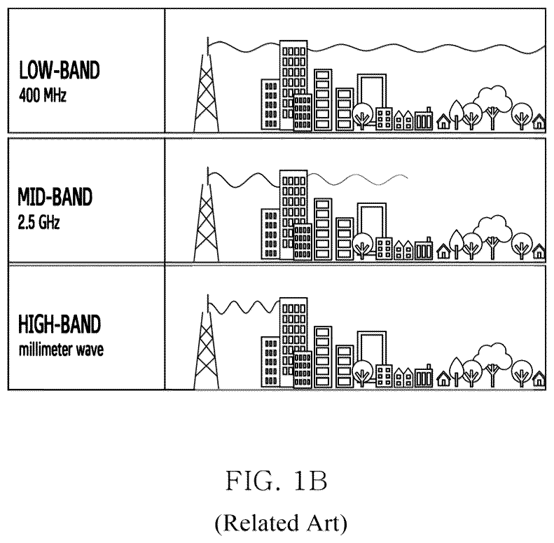

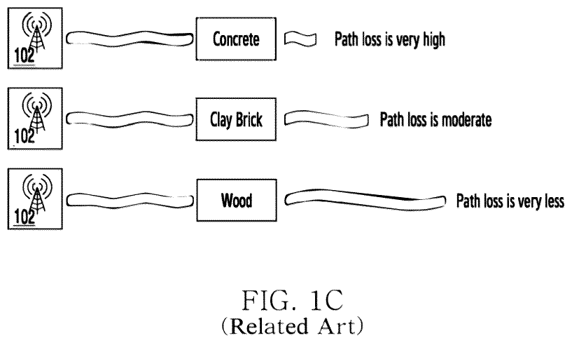

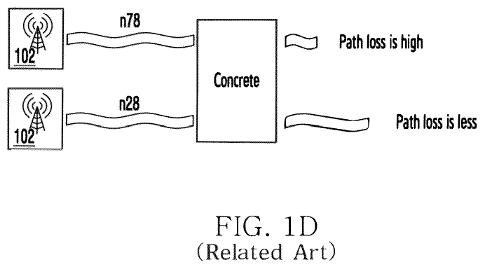

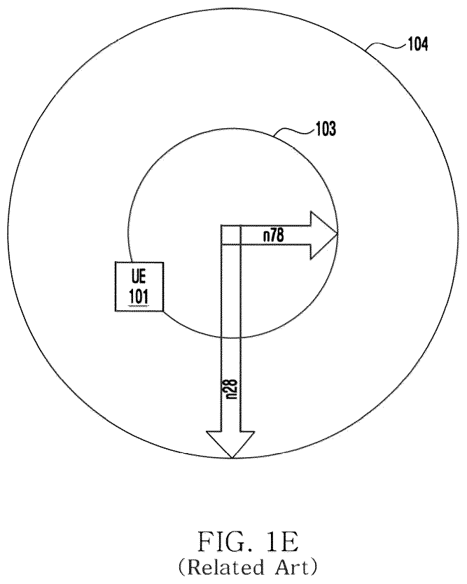

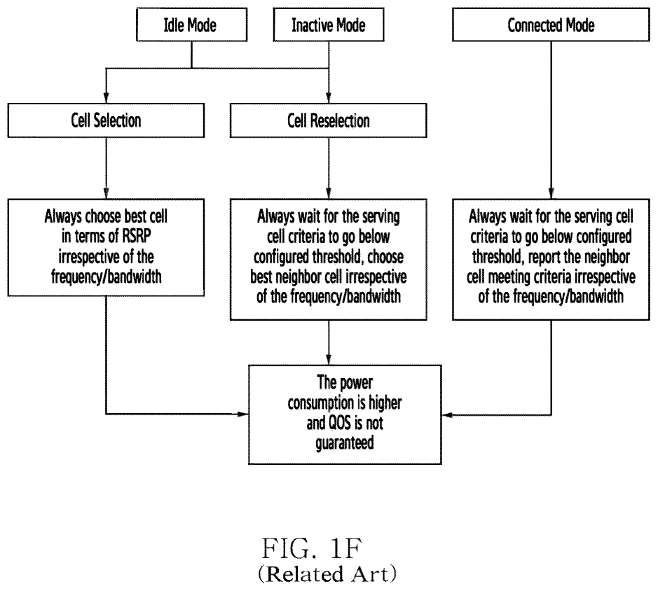

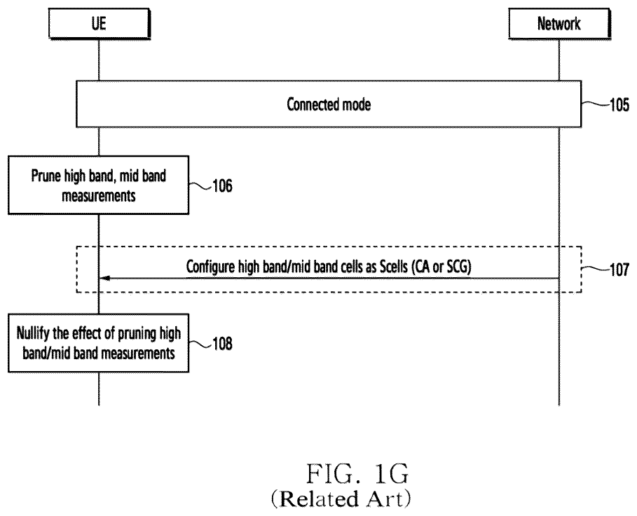

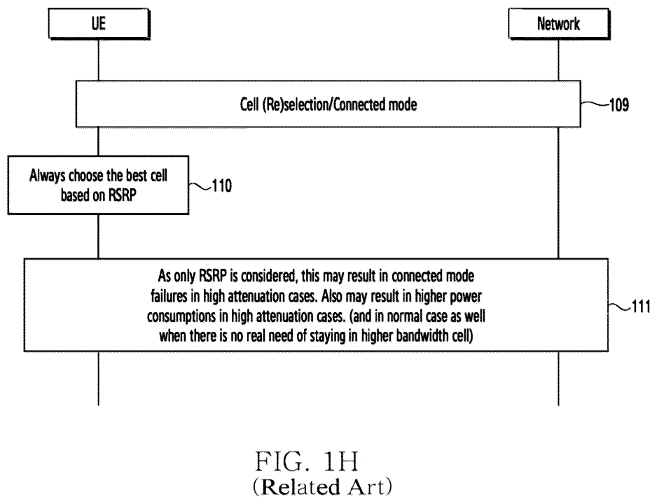

FIG. 1A is a graphical representation that illustrates the frequency-dependent attenuation of a signal as it passes through different materials, accordingly to the related art. Generally, as frequency increases, wavelength decreases and signal attenuation rises. This implies that the high band experiences the highest attenuation, followed by mid band, and then low band, which experiences the lowest attenuation. Signal attenuation is also influenced by the material through which the signal travels. Higher attenuation implies higher path loss, which adversely impacts UE performance, particularly in UL. Therefore, it is crucial to consider cell attenuation when selecting the most suitable cell for a location to enhance UE performance. As depicted in FIG. 1a, concrete blocks exhibit the highest attenuation, whereas polyethylene (dry) displays the least attenuation. Table 1 demonstrates the attenuation levels for concrete and wood in two different cells.

TABLE 1
Attenuation levels for concrete material and wood
Signal Attenuation With Concrete Material

| | Without Concrete | With Concrete | |
|---|---|---|---|
| | Obstruction | Obstruction | Signal Drop |
| Band | RSRP(dbm) | RSRP(dbm) | (Delta) |
| n78 | −81 | −93 | −12 |
| n28 | −74 | −76 | −2 |

Signal Attenuation With Wooden Material

| | Without Wooden | With Wooden | |
|---|---|---|---|
| | Obstruction | Obstruction | Signal Drop |
| Band | RSRP(dbm) | RSPP(dbm) | (Delta) |
| n78 | −89 | −95 | −6 |
| n28 | −81 | −86 | −5 |

FIG. 1B is an example diagram that distinguishes between low band, mid band and high band frequencies, accordingly to the related art. These frequency bands are broadly categorized into three groups, with low band frequencies offering extensive coverage capabilities that enable long-distance communication. As a result, they are ideal for providing coverage across expansive areas, including remote or hard-to-reach locations. However, it is worth noting that low band frequencies lack the speed or capacity characteristics that are inherent in higher bands. In particular, the performance of a low-band 5G network is typically similar to that of 4G LTE.

Mid-band frequencies represent a potent mix of speed, bandwidth, and coverage, occupying a position between high and low bands. For instance, a mid-band 5G network offers superior speed and capacity compared to a low-band 5G network while extending its coverage over greater distances than a high-band 5G network. Mid-band frequencies are well-suited for effectively servicing small cities, towns, and suburban areas, catering to the needs of both consumers and businesses. Mid-band 5G can cover more distance than high-band 5G, and with more speed and capacity than low-band 5G—it's a bit of a sweet spot with the range and capacity to serve small cities, towns and suburban areas, and both consumers and businesses.

High-band frequencies exhibit exceptionally rapid speed and tremendous bandwidth, earning them the moniker millimeter wave (mmWave). Due to the abundance of high-band spectrum available, mmWave technology boasts breathtaking performance. However, the high-energy waves travel shorter distances, making them ideal for use in dense urban settings or high-traffic venues where unparalleled speed and capacity capabilities are essential. Because of the quantity of high band spectrum available, mmWave has breathtaking performance. However, those high-energy waves travel shorter distances. Because of the speed and capacity they support, mmWave frequency bands are currently most often used in dense urban settings or at busy venues.

FIG. 1C is a schematic diagram that illustrates the path loss of different materials through which the signal traverses, accordingly to the related art. The path loss in wireless communication is affected by multiple factors, including the type of material through which the signal propagates. Typically, the free-space path loss (FSPL) equation characterizes the path loss as a baseline for signal attenuation in free space. However, when signals traverse through materials like concrete block, clay brick, or wood, additional path loss due to these materials must be considered. Concrete block, due to its density and composition, tends to cause relatively high path loss. The signals can experience absorption and reflection within the material. Clay brick, while less dense than concrete, still causes notable path loss. The extent of path loss depends on factors such as brick thickness and composition. Wood, on the other hand, is generally less dense than concrete or clay brick, resulting in lower path loss. However, the specific type of wood and moisture content can influence the attenuation. Since concrete is commonly used in buildings and structures, understanding its path loss characteristics is crucial for indoor wireless communication systems.

FIG. 1D is a schematic diagram illustrating the path loss for the concrete material through which the signal traverses, for two different cells, accordingly to the related art. FIG. 1D illustrates that the path loss experienced by an n78 (103) cell, operating at a higher frequency, surpasses that of the n28 (104) cell, which operates at a lower frequency and offers a broader coverage area. The frequency band n78 (103) corresponds to a range from 3300 MHz to 3800 MHz and is used for time division duplex (TDD). The frequency band n28 (104) corresponds to a downlink range from 1525 MHz to 1559 MHz and an uplink range from 1626.6 to 1660.5 MHz. The frequency band n28 (104) is used for frequency division duplex (FDD).

FIG. 1E is a schematic diagram that illustrates a scenario in which the UE selects the cell with better signal strength when the UE is at cell edge of two cells, accordingly to the related art. In the conventional approach, if the UE is situated at the cell edge of n78 (103) and n28 (104), it tends to prefer the n78 (103) cell when the signal quality is better for that particular cell. However, to prevent attenuation, the UE should opt for the n28 (104) cell as it provides lesser attenuation.

FIG. 1F is a flow diagram that illustrates drawbacks of the UE selecting best cell based on signal strength during cell selection or cell reselection, accordingly to the related art. During the process of cell selection in idle mode, the UE defaults to selecting the best available cells based on signal strength (e.g., RSRP), without taking into account frequency or bandwidth considerations. Similarly, during cell reselection in the inactive mode, the UE waits for the serving cell criteria to fall below the configured threshold in terms of received signal strength before selecting the best neighbor cell, regardless of frequency or bandwidth considerations. Additionally, during handover within the connected mode, the UE follows a similar procedure, waiting for the serving cell criteria to meet the configured threshold and reporting the neighbor cell that meets the criteria, without taking into account frequency or bandwidth parameters. However, when the UE is operating at a higher bandwidth or frequency, it must monitor resources across the entire bandwidth, which results in higher power consumption.

When the signal condition weakens and drops during idle mode due to attenuation, increased power consumption may arise for the following reasons: Devices operating in higher bandwidths perform resource monitoring across the entire bandwidth, and dropped measurements of the serving cell may necessitate neighbor cell measurements for multiple cells, including intra/inter frequency inter RAT.

When the signal condition deteriorates due to attenuation, the User Equipment (UE) in connected mode may experience suboptimal Quality of Service (QOS) in the uplink, especially with higher path loss. In such scenarios, the UE requires greater transmission power to compensate for the high path loss. However, if the necessary transmission power surpasses the maximum transmission power capacity, the likelihood of transmission failures increases, thereby adversely impacting the Key Performance (KP) of the uplink.

FIG. 1G is a sequence diagram that illustrates a scenario in which the network configures the pruned higher bands cells as secondary cells in the connected mode, accordingly to the related art. In operation 105, the UE is in the connected mode. In operation 106, The UE prunes measurements for high band, measurements for mid band. In operation 107, the network (e.g., base station) configures high band/mid band cells as secondary cells (SCells) (e.g., SCells of carrier aggregation (CA), SCells of secondary cell group (SCG)). Despite pruning measurements for certain bands, the network may still configure these bands as secondary cells based on the support indicated in the UE capability. As a result, configuring cells in pruned bands as secondary cells can nullify the impact of high band/mid band measurement pruning.

FIG. 1H is a sequence diagram that illustrates a scenario in which the UE selects the best cell based on RSRP during cell selection or cell reselection in the connected mode, accordingly to the related art. In operation 109, the UE is in the connection mode. During cell selection or reselection in the connected mode, in operation 110, the UE unfailingly selects the optimal cell based on RSRP. However, relying solely on RSRP as the cell selection criterion may lead to high attenuation instances in the connected mode, thereby resulting in increased power consumption. For example, in operation 111, the UE can connection failure on high band associated with high attenuation case. This holds true even in normal scenarios when there is no pressing need to remain in a higher bandwidth cell. Moreover, when the UE operates at higher bandwidth/frequency, it constantly monitors resources across the entire bandwidth, leading to escalated power consumption.

Unlike the conventional methods, in the disclosure, the UE employs a prioritization scheme that arranges cells in order of low band, mid band, and high band when signal attenuation is high or when higher bandwidths are unnecessary for normal UE operations. During cell selection in idle mode, the UE prioritizes lower bands over higher ones. In cell reselection during idle/inactive mode, the UE prunes measurements of higher bands unless signal conditions in lower bands deteriorate. During handover in the connected mode, the UE also prunes measurements of higher bands unless signal conditions in lower bands degrade or a high-data-rate service is triggered. This approach reduces UE power consumption and improves QoS.

FIG. 2 is a block diagram of a UE (201) for handling serving cell selection when the signal attenuation is high in a wireless network (202), accordingly to embodiments as disclosed herein. With reference to FIG. 2, the UE (201) can encompass a diverse range of devices, including but not limited to laptops, palmtops, desktops, mobile phones, smart phones, Personal Digital Assistants (PDAs), tablets, wearable devices, Internet of Things (IoT) devices, virtual reality devices, foldable devices, flexible devices, display devices, and immersive systems. In an embodiment, the UE (201) includes a memory (205), a communication processor (203), an Input/Output (I/O) interface (204), and a cell selection controller (206).

The memory (205) is configured to store instructions to be executed by the communication processor (203). The memory (205) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (205) may, in some examples, be considered a non-transitory storage medium. The term “non-transitory” may indicate that the storage medium is not embodied in a carrier wave or a propagated signal. However, the term “non-transitory” should not be interpreted that the memory (205) is non-movable. In some examples, the memory (205) is configured to store larger amounts of information. In certain examples, a non-transitory storage medium may store data that can, over time, change (e.g., in Random Access Memory (RAM) or cache).

The communication processor (203) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The communication processor (203) may include multiple cores and is configured to execute the instructions stored in the memory (205).

The I/O interface (204) transmits the information between the memory (205) and external peripheral devices. The peripheral devices are the input-output devices associated with the network apparatus. The I/O interface (204) receives several information from plurality of UEs, network devices, server and the like.

In an embodiment, the cell selection controller (206) of the UE (201) communicates with the processor (203), I/O interface (204) and memory (205) for handling serving cell selection when the signal attenuation is high in the wireless network (202). The cell selection controller (206) detects the trigger condition to initiate the cell selection or reselection or sending measurement report, wherein the trigger condition indicates the UE (201) is in one of the idle mode, the connected mode, and the inactive mode. The cell selection controller (206) determines the plurality of cells belonging to the predefined range of band frequency for camping the UE (201). Further, the UE (201) is camped to at least one cell from the plurality of cells belonging to the predefined lowest band frequency based on the trigger condition.

In an embodiment, the cell selection controller (206) determines whether the trigger condition indicates the UE (201) is in one of the idle mode, the connected mode, and the inactive mode. When the UE (201) is in the idle mode, the cell selection controller (206) detects the at least one cell from the plurality of cells belonging to the predefined lowest band frequency from the predefined range of band frequency, selects the at least one cell belonging to the predefined lowest band frequency within the predefined range of band frequency, and the UE is camped on the at least one selected cell belonging to the predefined lowest band frequency. When the UE (201) is in one of the inactive mode and the connected mode, the cell selection controller (206) detects the at least one cell from the plurality of cells belonging to the predefined lowest band frequency from the predefined range of band frequency. Further, the cell selection controller (206) prioritizes the at least one cell belonging to the predefined lowest band frequency within the predefined range of band frequency over the plurality of cells belonging to a predefined highest band frequency and a predefined mid band frequency with in the predefined range of band frequency, wherein the at least one cell belonging to the predefined lowest band frequency is prioritized based on the trigger condition and a plurality of operation parameters of the UE (201) indicated in the trigger condition, and the UE (201) is camped on the at least one prioritized cell belonging to the predefined lowest band frequency.

The cell selection controller (206) is a hardware component that is incorporated into the UE (201) through processing circuitry, comprising of logic gates, integrated circuits, microprocessors, microcontrollers, memory circuits, passive and active electronic components, optical components, hardwired circuits, or similar technologies. These circuits can be manifested in one or more semiconductor chips or on substrate supports such as printed circuit boards.

At least one of the plurality of components of the cell selection controller (206) may be implemented through an AI model. A function associated with the AI model may be performed through the memory (205) and the processor (203). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts the hardware components of the UE (201), it should be noted that alternative embodiments are not confined to these elements. The UE (201) may comprise a greater or lesser number of hardware components in other embodiments. Additionally, the labels or names assigned to these elements are purely for illustrative purposes and do not restrict the scope of the disclosure. Furthermore, it is possible for one or more components to be merged together to perform the same or a substantially similar function.

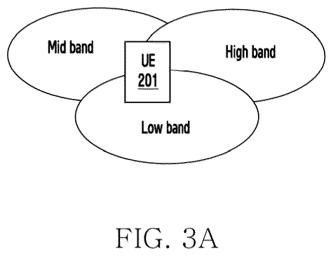

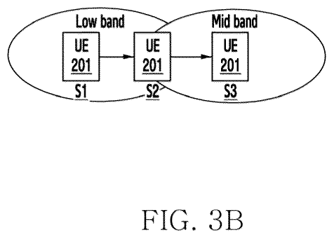

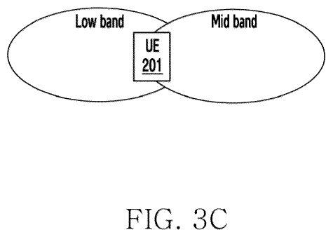

FIG. 3A depicts a scenario in which the UE (201) is located within an overlapping region of cells operating in the low, mid, and high frequency bands, accordingly to the embodiments as disclosed herein. With regards to FIG. 3a, the UE (201) finds itself situated within the overlapping terrain of the low, mid, and high band cells. Despite the RSRP level, the UE (201) opts to remain within the low band cell when signal attenuation is high or when any of the trigger conditions are met. For example, to classify the frequency characteristics, frequency bands may be divided into three frequency categories. The first frequency category comprises low frequency bands (e.g., ˜1 GHz). The second frequency category comprises mid frequency bands (e.g., 1 GHZ˜7.125 GHZ). In one example, the first and second frequency category may be referred as frequency range (FR) 1, specified in 3GPP Standard. The third frequency category comprises high frequency bands (e.g., mmWave, or above 24.25 GHz). In one example, the third frequency category may be referred as FR 2 (or FR 2-1, FR 2-2). Each frequency category comprises one or more frequency bands. Each frequency bands comprises one or more cells. For convenience of explanation, the cell in the mid frequency band may be referred as mid band cell. The cell in the low frequency band may be referred as low band cell, the cell in the high frequency band may be referred as high band cell. The cell has a carrier frequency (or center frequency) and a bandwidth. Furthermore, hereinafter, the expression “cell belonging to lowest band frequency” refers to that the cell belongs to the first frequency category (i.e., low-band). The expression “cell belonging to mid band frequency” refers to that the cell belongs to the second frequency category (i.e., mid-band). The expression “cell belonging to highest band frequency” refers to that the cell belongs to the third frequency category (i.e., high-band).

In an embodiment, the trigger conditions may include, but are not limited to, the UE (201) screen status being maintained for a specific duration, the UE (201) being configured in a power saving mode, the attenuation level of the UE (201), the quality of service (QOS) level of the UE (201), the audio status of the UE (201), the transmitted signal power level of the UE (201), the path loss level of the UE (201), the data rate level of the UE (201), the random access channel (RACH) failure level of the UE (201), the block error rate (BLER) level of the UE (201), and the RSRP level of the UE (201).

For example, the following cases may be trigger conditions for using embodiments.

### Idle/Inactive Mode:

Screen Off (for ‘X’ duration; X can be a configurable value including 0)
User enabled power saving mode
Device inside a room constructed using material that can cause higher attenuation

### Connected Mode:

Screen Off (for ‘X’ duration; X can be a configurable value including 0)
User enabled power saving mode

### Poor QOS

Continuous audio mute
Calculated Tx power is very high that the max possible Tx power
Very high pathloss
Low data rate
High UL/DL BLER
Continuous/high RACH failure
Device inside a room constructed using material that can cause higher attenuation.

FIG. 3B illustrates a scenario in which the UE (201) transitions from a low band cell to a mid-band cell, accordingly to the embodiments as disclosed herein. The UE (201) is stationed on the low band cell and gradually transitions towards the mid band cell. In the area where the low band cell and the mid band cell intersect and the mid band cell signal is potent, the UE (201) will persist in discarding mid band cell measurements and accord priority to the low band cell until the signal from the latter falls below a predetermined threshold. These thresholds are meticulously calibrated to ensure that the UE (201) never loses connectivity to the network (202).

In an embodiment, the selective removal of measurements from higher band cells and prioritization of lower band cells is executed solely upon meeting specific trigger conditions. Furthermore, the cessation of pruning measurements from higher band cells is determined by the exit criteria of various services and the signal conditions of the serving cell.

FIG. 3C depicts a scenario in which the UE (201) prioritizes the low band cell over the mid band cell, accordingly to the embodiments as disclosed herein. In FIG. 3C, UE (201) is currently situated in an area with robust coverage from the mid band cell. As a result, UE (201) will persist in disregarding mid band cell measurements and instead prioritize low band cell measurements until the signal strength from the latter falls below the predetermined threshold. These thresholds have been thoughtfully established to ensure that UE (201) never loses connectivity with the network (202).

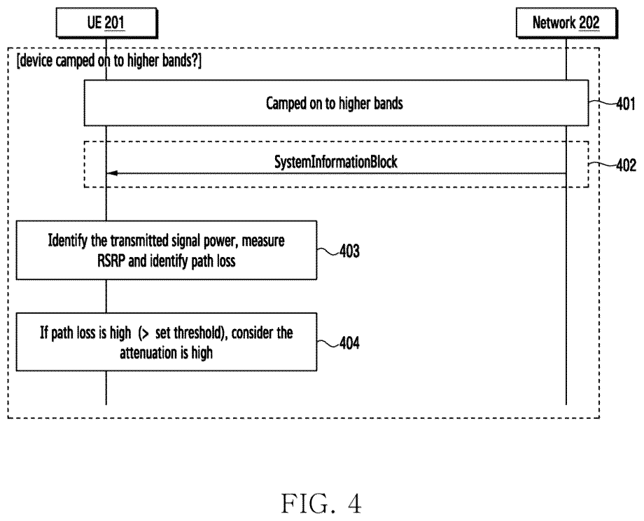

FIG. 4 is a sequence diagram that illustrates a scenario attenuation is detected based on the received RSRP at the UE (201), accordingly to the embodiments as disclosed herein. The UE (201) is currently camped on the cells (operation 401) operating on the higher frequency band. In wireless communication, the network (202) broadcasts SIBs (operation 402) to impart information to the UE (201). To detect attenuation in SIBs, the signal quality and strength of the broadcasted information elements are vigilantly monitored (operation 403). The UE (201) typically measures signal strength and quality, including RSRP, reference signal received quality (RSRQ), and/or path loss. A decline in the RSRP or RSRQ values signifies a reduction or degradation in the received signal strength. When the path loss is high and exceeds a predetermined threshold, it is indicative of higher attenuation being detected (operation 404).

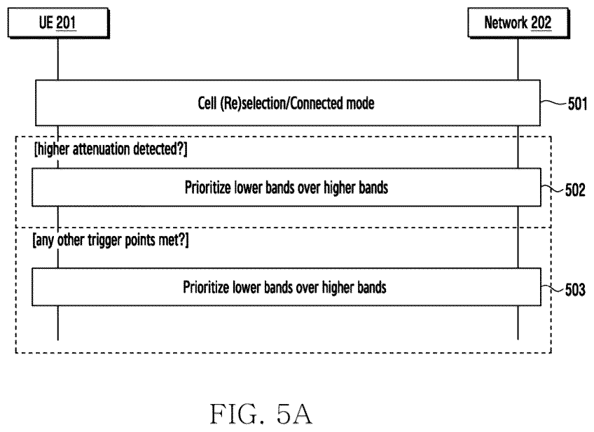

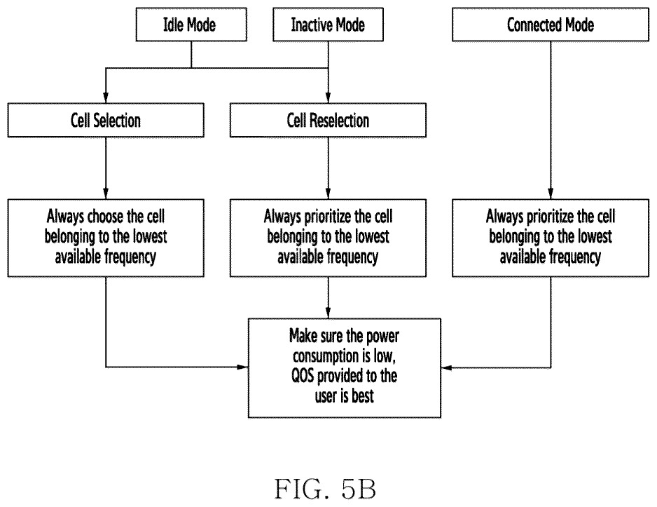

FIG. 5A is a sequence diagram that illustrates a scenario in which the UE (201) prioritizes the lower band cells upon meeting the trigger condition, accordingly to the embodiments as disclosed herein. During the process of cell selection/reselection or while the UE (201) is in the connected mode (operation 501) and detects high attenuation, it gives preference to the lower band cell over the high band cell (operation 502). Similarly, for any other trigger points, the UE (201) prioritizes the lower band cell over the high band cell (operation 503). This approach eliminates the need for higher transmission power when the path loss is high, resulting in optimized power consumption for the UE (201) and improved QoS.

FIG. 5B is a flow diagram that illustrates the prioritization of lower band cells by the UE (201) during the idle mode, inactive mode, and connected mode, accordingly to the embodiments as disclosed herein. During the idle mode's cell selection process, the UE (201) opt for the cell with the lowest available frequency and establishes a connection to the cell with the lowest frequency band. Similarly, during the inactive mode's cell reselection, the UE (201) gives priority to the cell with the lowest available frequency and establishes a connection to the cell with the lowest frequency band. In the connection mode, the UE (201) perform measurements to identify whether the triggering connection is satisfied or not. In case that the triggering condition is satisfied, the UE (201) is configured to transmit measurement report including the result of the measurements to the network. During the handover process within the connected mode, the UE (201) prioritizes the cell with the lowest available frequency and submits the measurement report to the network (202).

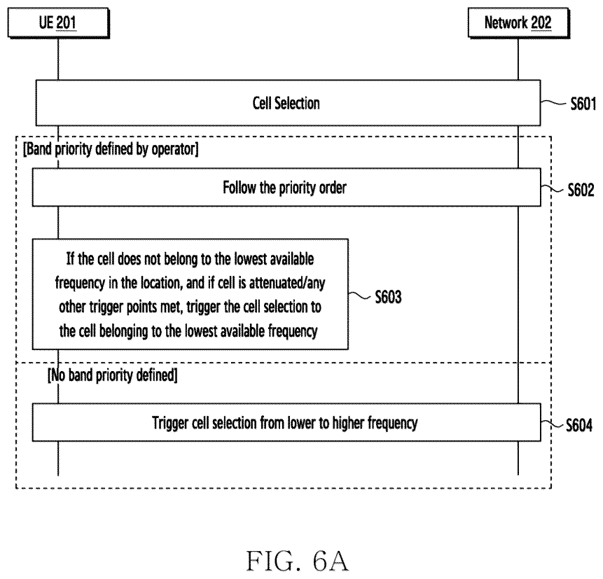

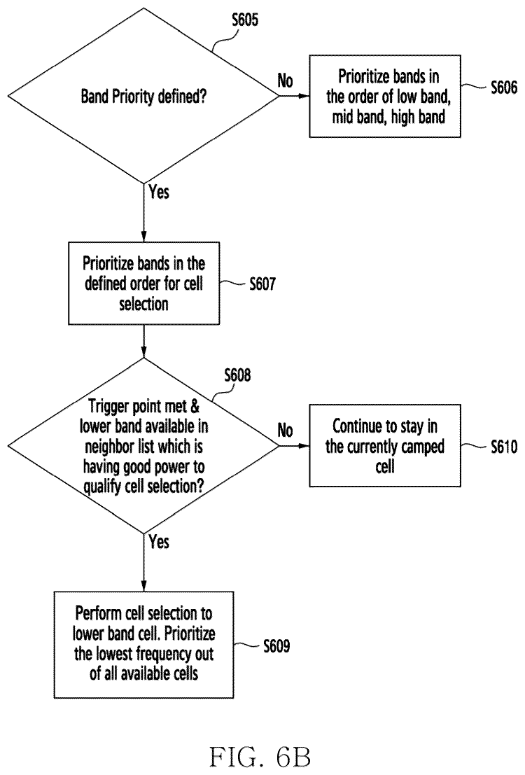

FIG. 6A is a sequence diagram that illustrates a scenario in which the UE (201) prioritizes the lower band cells while selecting cell in the idle mode, accordingly to the embodiments as disclosed herein. In operation S601, the UE (201) undertakes cell selection in the idle mode. At operation S602, when the operator or service provider defines the band priority for cell selection in the idle mode, the UE (201) adheres to the priority order established by the operator. Operation S603 involves triggering cell selection to the lowest available frequency cell when the UE (201) is camped in a non-lowest frequency cell that is attenuated or meets trigger points. Further, in operation S604, when no band priority is provided to the UE (201), it prioritizes cell selection in the order of low band, mid band, and high band.

FIG. 6B is a flow diagram that illustrates the prioritization of lower band cells by the UE (201), in the event that a band priority has been established, accordingly to the embodiments as disclosed herein. At operation S605, the determination is made as to whether the operator has defined the band priority. At operation S606, in the absence of a defined band priority, the UE (201) prioritizes cells in the low, mid, and high bands in that order during cell selection. At operation S607, when the operator has defined the band priority, the frequency bands are prioritized according to the defined order for cell selection. At operation S608, a decision is made as to whether the trigger points have been met and if lower band cells with good power are available in the neighbor list to qualify for cell selection. If the trigger points are met and lower band cells with good power are available in the neighbor list, the lowest frequency cell out of all available cells is prioritized, and cell selection to the prioritized lowest frequency band cell is performed at operation S609. At operation S610, if no trigger points are met, the UE (201) remains in the currently camped cell.

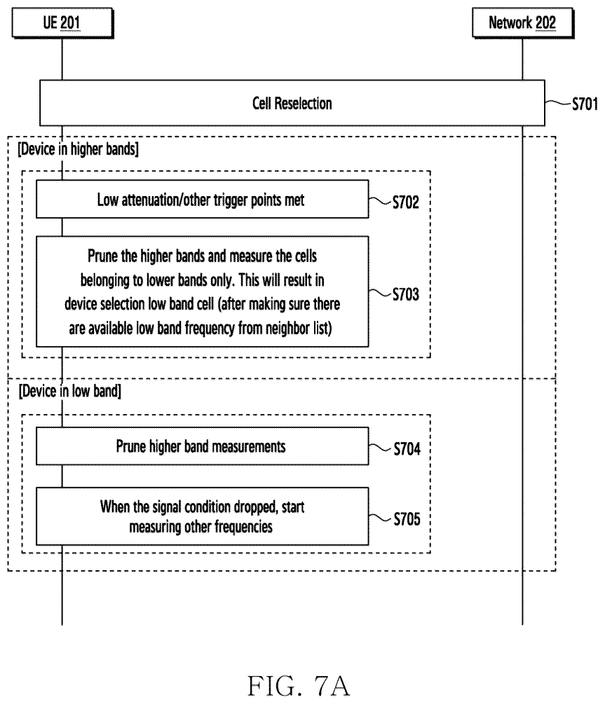

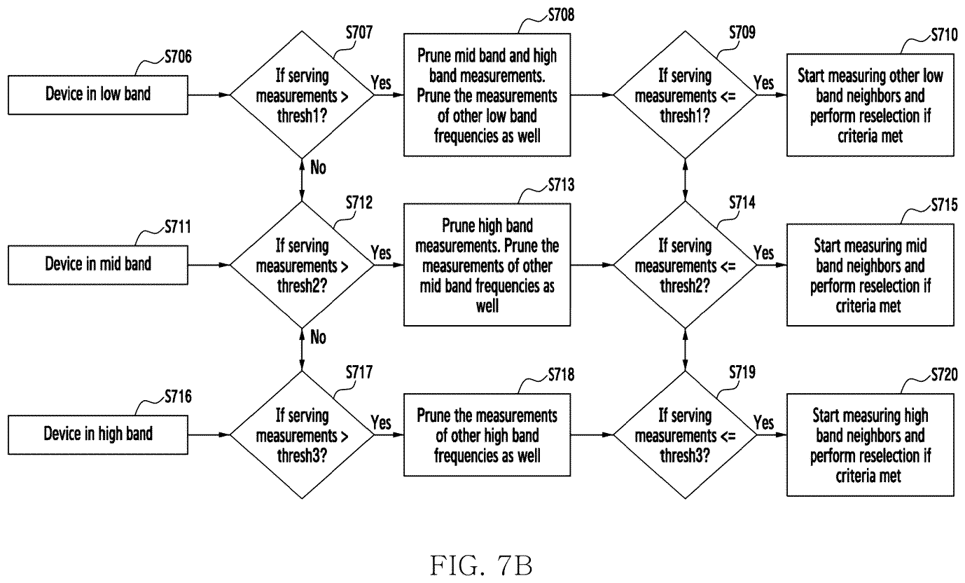

FIG. 7A is a sequence diagram that illustrates a scenario of the UE (201) prioritizes the lower band cells while performing the cell reselection in the idle/inactive mode, accordingly to the embodiments as disclosed herein. In operation S701, the UE (201) initiates cell reselection with the network (202). In operation S702, if the UE (201) is in higher bands and experiences high attenuation while meeting the trigger point criteria, it proceeds to operation S703 where it measures only the lower frequency band cells and prunes the measurements of the higher frequency band cells. Similarly, in operation S704, when the UE (201) is in lower bands and meets the trigger point criteria, it prunes the measurements of the higher frequency band cells. Further, in operation S705, if the signal condition of the currently camped cell drops, the UE (201) starts measuring other neighbor cells.

FIG. 7B is a sequence diagram that illustrates a scenario in which the UE (201) prioritizes cells in the lower band during the cell reselection in the idle/inactive mode. This prioritization is based on predefined thresholds, accordingly to the embodiments as disclosed herein. At operation S706, the UE (201) resides in a low band frequency cell. At operation S707, a decision is then made as to whether the serving cell measurements exceed a first predefined threshold. If so, at operation S708, the UE (201) prunes the measurements of mid and high band cells, as well as other neighbor cells of the low band frequency. If the serving cell measurements are less than or equal to the first predefined threshold (operation S709), the UE (201) commences measuring other neighbor cells of the low band at operation S710 and performs cell reselection when the criteria are met.

Once the UE (201) is in a mid-band frequency cell at operation S711, a decision is made as to whether the serving cell measurements exceed a second predefined threshold at operation S712. When the measurements surpass the threshold, the UE (201) prunes the measurements of high band cells and other neighbor cells of the mid band frequency at operation S713. If the measurements fall below the second predefined threshold (operation S714), the UE (201) initiates measuring other neighbor cells of the mid band at operation S715 and performs cell reselection when the criteria are met.

Further, when the UE (201) is in a high band frequency cell at operation S716, a decision is made as to whether the serving cell measurements exceed a third predefined threshold at operation S717. If so, at operation S718, the UE (201) prunes the measurements of other neighbor cells of the high band frequency. Further, if the measurements are less than or equal to the third predefined threshold (operation S719), the UE (201) commences measuring other neighbor cells of the high band at operation S720 and performs cell reselection when the criteria are met.

In an embodiment, the initial predetermined threshold marks the commencement of measurements on the remaining low band frequencies. The subsequent predetermined threshold signifies the initiation of measurements on the remaining mid band frequencies. Further, the third predetermined threshold denotes the beginning of measurements on the remaining high band frequencies. These thresholds are thoughtfully established to ensure that the UE (201) remains continuously connected to the network (202), without the risk of service disruption.

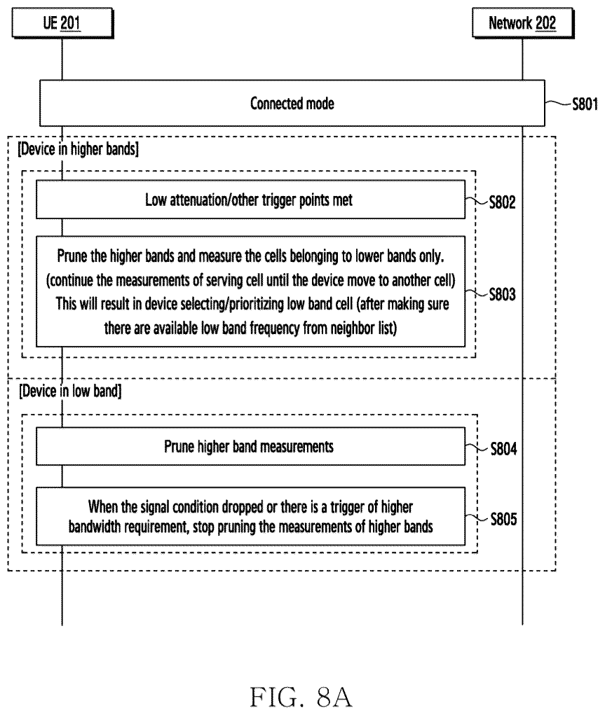

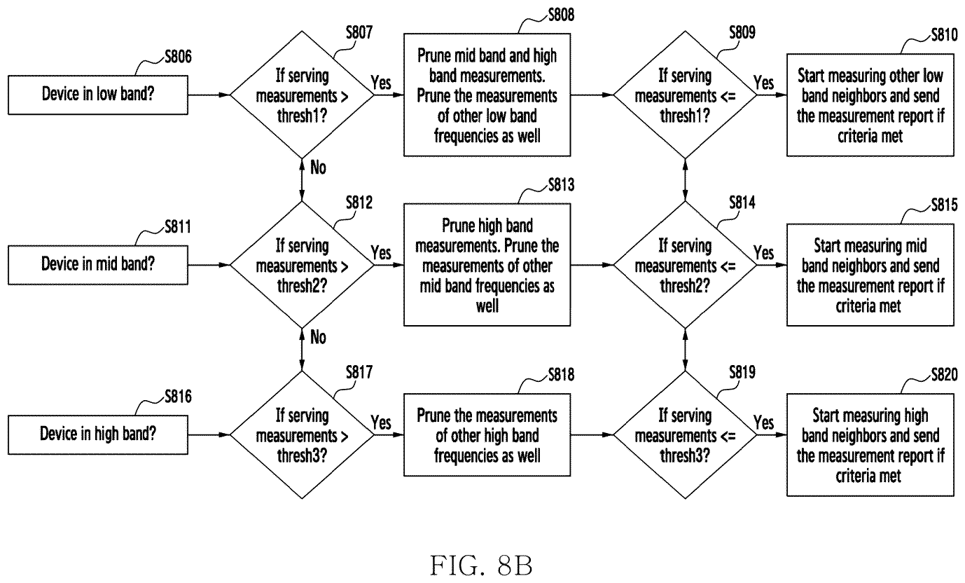

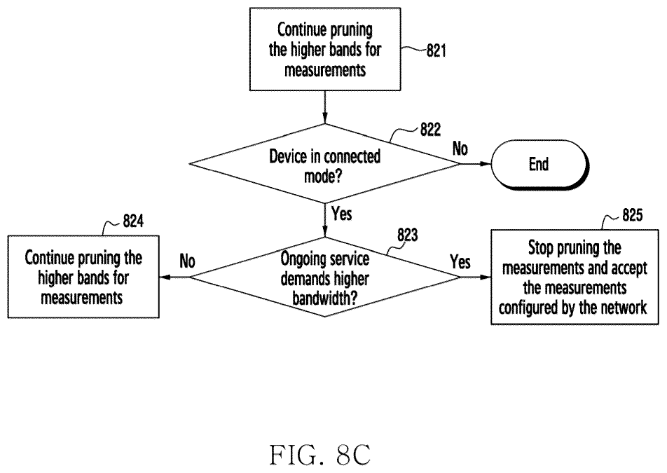

FIG. 8A is a sequence diagram that illustrates a scenario in which the UE (201) prioritizes the lower band cells in the connected mode, accordingly to the embodiments as disclosed herein. In operation S801, the UE (201) in the connected mode performs a handover with the network (202). In operation S802, when the UE (201) is operating in higher bands and experiences high attenuation while meeting certain criteria, it detects trigger points. In operation S803, once lower frequency band cells become available, the UE (201) measures only those cells and prunes measurements of higher frequency band cells. The UE (201) continues measuring serving cells until it moves to another cell. In operation S804, when the UE (201) is in lower bands, it prunes measurements of higher frequency band cells upon meeting trigger points. Further, in operation S805, if the signal condition of the currently camped cell drops or a trigger condition for higher bandwidth requirement is detected, the UE (201) stops pruning measurements of high band cells.

FIG. 8B is a sequence diagram that illustrates a scenario in which the UE (201) prioritizes the lower band cells while in the connected mode, in accordance with the predefined thresholds, accordingly to the embodiments as disclosed herein. At operation S807, the UE (201) resides in the low band frequency cell and a decision is made whether the serving cell measurements exceed the first predefined threshold. If they do, at operation S808, the UE (201) prunes the measurements of mid and high band cells, as well as other neighbor cells of the low band frequency. On the other hand, if the serving cell measurements are less than or equal to the first predefined threshold, at operation S810, the UE (201) initiates measurements of other neighbor cells of the low band and sends the measurement report to the network (202) once the cell reselection criteria is met.

Further, at operation S811, the UE (201) moves to the mid band frequency cell and a decision is made whether the serving cell measurements exceed the second predefined threshold. If they do, at operation S813, the UE (201) prunes the measurements of high band cells and other neighbor cells of the mid band frequency. Further, if the serving cell measurements are less than or equal to the second predefined threshold, at operation S815, the UE (201) initiates measurements of other neighbor cells of the mid band and sends the measurement report to the network (202) once the cell reselection criteria is met.

Further, at operation S816, the UE (201) moves to the high band frequency cell and a decision is made whether the serving cell measurements exceed the third predefined threshold. If they do, at operation S818, the UE (201) prunes the measurements of other neighbor cells of the high band frequency. However, if the serving cell measurements are less than or equal to the third predefined threshold, at operation S820, the UE (201) initiates measurements of other neighbor cells of the high band and sends the measurement report to the network (202) once the cell reselection criteria is met.

In an embodiment, the first, second, and third predefined thresholds can be customized and may not necessarily match the thresholds specified in the idle mode scenario.

FIG. 8C is a flow diagram that illustrates the UE's ability to halt the pruning of higher bands for measurements in the connected state, in response to a need for increased bandwidth to support ongoing services, accordingly to the embodiments as disclosed herein. Upon detecting high attenuation or meeting the trigger condition, the UE (201) commences prioritizing lower band cells and selectively prunes measurements of higher band cells. In operation 821, the UE (201) continues to prune measurements of higher band cells until it camps on the lowest available frequency band cell. At operation 822, the UE (201) determines if it is in the connected mode. At operation 823, a decision is made if an ongoing service requires higher bandwidth. If the ongoing service does not require higher bandwidth, the UE (201) continues to prune measurements for higher frequency band cells at operation 824. However, if the ongoing service requires higher bandwidth, the UE (201) stops pruning measurements for higher frequency band cells and accepts measurements configured by the network (202) at operation 825.

In an embodiment, the UE (201) has the capability to store the bandwidth allocation for a given band and Public Land Mobile Network (PLMN) (operator) in order to prioritize frequency bands. The determination of bandwidth requirement is based on buffer occupancy and data arrival at the Packet Data Convergence Protocol (PDCP) of the UE (201). The UE (201) ceases to prune measurements when the buffer occupancy or data arrival at the PDCP is high. An example of the higher bandwidth evaluation scenario is illustrated in Table 2.

TABLE 2
Need for higher bandwidth evaluation

| | | | | Need of |
|---|---|---|---|---|
| Buffer | | | | higher |
| Occupancy | Data Arrival | Latency | Data Type | BW? |
| Low | Medium/ | Low | Frequent + | No |
| | High | | Urgent small | |
| | | | Data | |
| Low | Medium/ | No latency | Frequent + | No |
| | High | requirement | small Data | |
| Low | Low | Low | Infrequent + | No |
| | | | Urgent small | |
| | | | data | |
| Low | Low | No latency | Infrequent + | No |
| | | requirement | small data | |
| Medium/ | Medium/ | Low | Frequent + | Yes |
| High | High | | Urgent | |
| | | | medium/high | |
| | | | data | |
| Medium/ | Medium/ | No latency | Frequent + | Yes |
| High | High | requirement | medium/high | |
| | | | data | |
| Medium/ | Low | Low | Infrequent + | Yes |
| High | | | Urgent | |
| | | | medium/high | |
| | | | data | |
| Medium/ | Low | No latency | Infrequent + | Yes |
| High | | requirement | medium/high | |
| | | | data | |

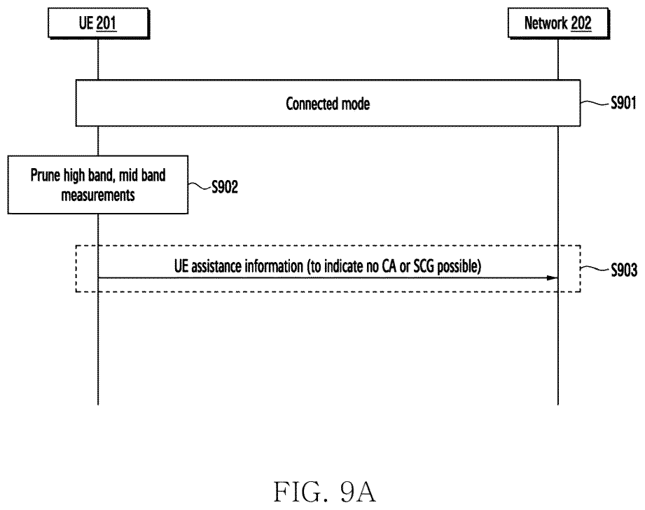

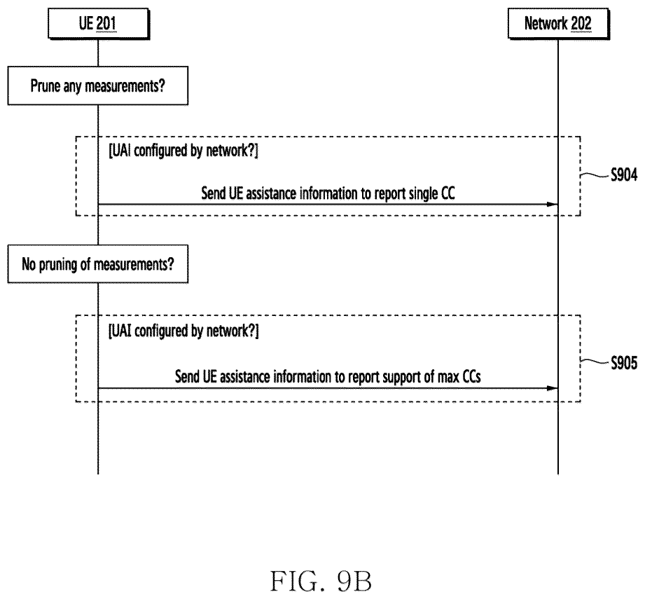

FIG. 9A is a sequence diagram that illustrates a scenario in which the UE (201) reports a UAI to the network (202) in the connected mode, accordingly to the embodiments as disclosed herein. In the connected mode (S901), the UE (201) commences pruning measurements of mid band and high band cells (S902) to prioritize lower frequency band cells in the event of high attenuation or trigger points being met. At operation S903, the UE (201) notifies the network (202) of the unavailability of CA due to the measurement pruning, thereby avoiding unnecessary CA configurations. Additionally, the UE (201) reports MIMO, DC, and other such details to the network (202) for configuration control. Pruning measurements of higher band cells is considered a trigger point for UAI transmission to the network (202).

FIG. 9B is a sequence diagram that illustrates a scenario in which the UE (201) reports the UAI to the network (202) during pruning and non-pruning of the measurements, accordingly to the embodiments as disclosed herein. As the UE (201) enters connected mode, it begins to selectively prune measurements of mid and high band cells to prioritize the lower frequency band cell at operation S904. In doing so, the UE (201) transmits the UAI to the network (202), indicating its support for a single Carrier Component (CC) to control unnecessary Carrier Aggression (CA) configurations. Further, if no pruning of frequency band cell measurements occurs at operation S905, the UE (201) sends the UAI to the network (202), reporting its support for the maximum CCs.

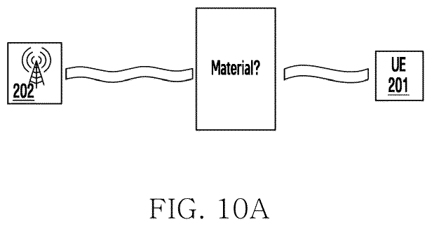

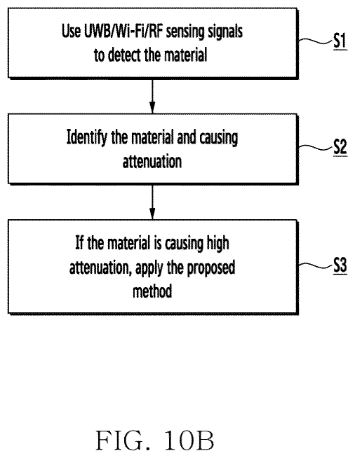

FIG. 10A is a schematic diagram that illustrates the material in which the UE (201) is situated, accordingly to the embodiments as disclosed herein. Various techniques, such as Ultra-Wideband (UWB), Wi-Fi, and Radio Frequency (RF) sensing, are utilized to identify the material that obstructs the UE (201). By emitting signals in all directions and analyzing the reflected signals from different materials, the direction and type of the blocking material can be determined. In instances where the signal is significantly weakened by the obstruction, the UE (201) will select an alternative low band cell to connect to, thereby avoiding attenuation.

FIG. 10B is a schematic diagram that illustrates a method of identifying the material behind which the UE (201) is situated, accordingly to the embodiments as disclosed herein. In operation S1, the UE (201) emits UWB, Wi-Fi, or RF sensing signals in all directions to detect the material obstructing its view. In operation S2, the UE detects signals reflected from the material and identifies its type based on the reflected signals. In operation S3, if the material is causing attenuation, the present solution is applied to avoid excessive power consumption and reduced QoS.

Based on the above description, the UE (201) may prioritize lower band during the stored or initial cell selection in RRC idle mode. The UE (201) may avoid measuring the higher bands unless the signal condition of lower band is dropped in case of RRC idle/inactive mode. In case of RRC connected mode, the UE (201) may avoid measuring higher frequencies unless the signal condition of lower frequencies are dropped or any service which need higher data rate is triggered/ongoing. For example, if a device is inside the room, there will be higher attenuation based on the type of material use to construct the room. Band prioritization should also be done based in such cases.

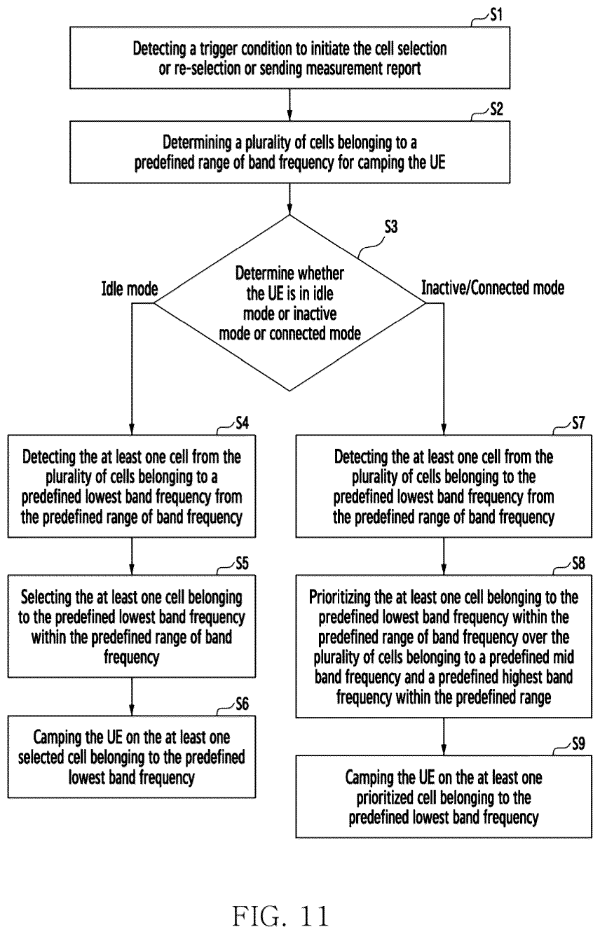

FIG. 11 is a flow chart that illustrates a method of handling serving cell selection when the signal attenuation is high in the wireless network (202), accordingly to the embodiments as disclosed herein. At operation S1, the UE (201) detects the trigger condition to initiate the cell selection in the idle mode or reselection in the idle/inactive mode or sending measurement report in the connected mode for the handover mechanism.

At operation S2, the UE (201) determines the plurality of cells belonging to the predefined range of band frequency in the network (202) for camping the UE (201). The plurality of cells includes all the available cells in a particular location where the UE (201) is currently camped on.

At operation S3, decision is made whether the UE (201) is in the idle mode or the inactive mode or the connected mode by the UE (201).

At operation S4, when the UE (201) is in the idle mode, the UE (201) detects the at least one cell from the plurality of cells belonging to a predefined lowest band frequency from the predefined range of band frequency. In an embodiment lowest band frequency is selected because the lowest frequency band offers least attenuation.

At operation S5, in an idle mode, the UE (201) opts for at least one cell that pertains to the lowest frequency band within a pre-established range of band frequencies.

At operation S6, upon selecting at least one cell belonging to the predefined lowest band frequency within the predefined range of band frequency, the UE (201) in idle mode gracefully camps to the selected cell.

In an embodiment, the method includes camping by the UE (201) to at least one cell from the plurality of cells belonging to a predefined lowest available band frequency based on the trigger condition, when a band priority is defined by an operator.

At operation S7, when the UE (201) is either in an inactive or connected mode, it detects at least one cell from a plurality of cells that belong to the predefined range of band frequency, specifically the lowest band frequency. This selection is based on the fact that the lowest frequency band offers the least amount of attenuation.

At operation S8, the UE (201) in either inactive or connected mode, gives precedence to at least one cell that belongs to the lowest band frequency within the predefined range of band frequency, over a multitude of cells that belong to a mid-band frequency and the highest band frequency within the same range.

In an embodiment, the cells within the predetermined frequency range are classified into three categories: the lowest band frequency category, the mid band frequency category, and the highest band frequency category.

In an embodiment the method includes receiving by the UE (201), the RSRP for the plurality of cells belonging to the predefined range of band frequency. Further, the method includes performing by the UE (201), pruning measurements of the plurality of cells belonging to the predefined mid band frequency and the predefined highest band frequency within the predefined range of band frequency, and other neighbour cells belonging to the predefined lowest band frequency when the RSRP of the plurality of cells belonging to the predefined range of band frequency is within a first predefined threshold range. The method includes performing by the UE (201), pruning the measurements of the plurality of cells belonging to the predefined highest band frequency within the predefined range of band frequency, and the other neighbour cells belonging to the predefined mid band frequency when the RSRP of the plurality of cells belonging to the predefined range of band frequency is within a second predefined threshold range. Further, the method includes performing by the UE (201), pruning the measurements of the other neighbour cells belonging to the predefined highest band frequency when the RSRP of the plurality of cells belonging to the predefined range of band frequency is within a third predefined threshold range.

At operation S9, the UE (201) camps to the at least one prioritized cell belonging to the predefined lowest band frequency after prioritizing the at least one cell belonging to the predefined lowest band frequency within the predefined range of band frequency.

In an embodiment, when the UE (201) is in the inactive mode, the UE (201) performs the cell reselection to camp on the at least one prioritized cell belonging to the predefined range of band frequency. When the UE (201) is in the connected mode, the UE (201) sends the measurement report to the network (202) to camp on the at least one prioritized cell belonging to the predefined range of band frequency.

In an embodiment, the method includes camping by the UE (201) to at least one cell from the plurality of cells belonging to a predefined lowest available band frequency based on the trigger condition, when a band priority is defined by an operator.

In an embodiment, the method includes suspending the pruning of the measurements of the plurality of cells belonging to the predefined range of band frequency when an ongoing service in the connected mode requires a high bandwidth.

In the conventional approach, signal attenuation increases with higher frequencies and varies depending on the material it must pass through. Greater attenuation results in higher path loss, which can adversely affect device performance, particularly in the uplink. Existing methods choose the best cell based solely on signal condition, without considering path loss, signal attenuation, or bandwidth. This oversight can lead to increased power consumption and poor quality of service for the user.

Under the disclosure, the UE prioritize the lowest available frequency cell unless a service requires a higher frequency. The method prioritizes the lower frequency cell during the cell selection and reselection process, based on different measurement thresholds of the serving cell and connected mode measurements. Multiple trigger points for UE Assistance Information (UAI) are based on serving cell measurements. The solution also includes a method to decide whether to prune or not prune measurements based on the services and bandwidth requirements. Overall, the disclosure can significantly reduce power consumption while improving the quality of service.

As frequency increases, the wavelength decreases, leading to a higher signal attenuation. Additionally, the attenuation of a signal is influenced by the material it must pass through, with greater attenuation resulting in higher pathloss. This can have a significant impact on device performance, particularly in the uplink. To address this issue, the proposed method takes into account the attenuation of cells in a given location and selects the most appropriate one to avoid any performance degradation.

The proposed method presented prioritizes lower frequency cells during the cell selection process, ensuring that the UE selects a lower band cell based on the service it requires, thereby conserving power. This approach is essential for enhancing battery life and improving the quality of service (QOS) for UE users. By consistently selecting lower frequency cells, the proposed method not only prolongs the battery life of the device but also delivers an enhanced QoS experience to the user.

In embodiments, a method for handling serving a cell selection or a reselection for a user equipment (UE) in a wireless network is provided. The method comprises detecting, by the UE, a trigger condition to initiate the cell selection or the reselection or sending a measurement report, wherein the trigger condition indicates that the UE is in one of an idle mode, a connected mode, and an inactive mode; determining, by the UE, a plurality of cells belonging to a predefined range of a band frequency for camping the UE; and based on the trigger condition, camping, by the UE, to at least one cell from the plurality of cells belonging to a predefined lowest band frequency.

For example, the camping, by the UE, to the at least one cell comprises determining, by the UE, whether the trigger condition indicates that the UE is in one of the idle mode, the connected mode, and the inactive mode; performing, by the UE, one of when the UE is in the idle mode, detecting the at least one cell from the plurality of cells belonging to the predefined lowest band frequency from the predefined range of band frequency, selecting the at least one cell belonging to the predefined lowest band frequency within the predefined range of band frequency, and camping, by the UE, to the at least one selected cell belonging to the predefined lowest band frequency; and when the UE is in one of the inactive mode and the connected mode, detecting the at least one cell from the plurality of cells belonging to the predefined lowest band frequency from the predefined range of band frequency, prioritizing the at least one cell belonging to the predefined lowest band frequency within the predefined range of band frequency over the plurality of cells belonging to a predefined highest band frequency and a predefined mid band frequency with in the predefined range of band frequency, wherein the at least one cell belonging to the predefined lowest band frequency is prioritized based on the trigger condition and a plurality of operation parameters of the UE indicated in the trigger condition, and camping, by the UE, to the at least one prioritized cell belonging to the predefined lowest band frequency.

For example, the plurality of operation parameters comprise at least one of a screen status of the UE for a period of time, a power saving mode configuration of the UE, an attenuation level of the cells, a Quality of Service (QOS) level of the UE, an audio status of the UE, a transmitted signal power level of the UE, a path loss level of the UE, a data rate level of the UE, a Random Access Channel (RACH) failure level of the UE, a Block Error Rate (BLER) level of the UE, and a Reference Signal Received Power (RSRP) level of the UE.

For example, the plurality of cells belonging to the predefined range of band frequency is categorized into a predefined lowest band frequency, a predefined mid band frequency, and a predefined highest band frequency.

For example, the prioritizing the at least one cell belonging to the predefined lowest band frequency within the predefined range of band frequency over the plurality of cells belonging to the predefined highest band frequency and the predefined mid band frequency with in the predefined range of band frequency, comprises receiving, by the UE, a Reference Signal Received Power (RSRP) for the plurality of cells belonging to the predefined range of band frequency; performing, by the UE, one of pruning measurements of the plurality of cells belonging to the predefined mid band frequency and the predefined highest band frequency within the predefined range of band frequency, and other neighbour cells belonging to the predefined lowest band frequency when the RSRP of the plurality of cells belonging to the predefined range of band frequency is within a first predefined threshold range; pruning the measurements of the plurality of cells belonging to the predefined highest band frequency within the predefined range of band frequency, and the other neighbour cells belonging to the predefined mid band frequency when the RSRP of the plurality of cells belonging to the predefined range of band frequency is within a second predefined threshold range; and pruning the measurements of the other neighbour cells belonging to the predefined highest band frequency when the RSRP of the plurality of cells belonging to the predefined range of band frequency is within a third predefined threshold range.

For example, the method comprises determining, by the UE, whether the UE is in one of the inactive mode, and the connected mode; performing, by the UE, one of when the UE is in the inactive mode, performing the cell reselection to camp on the at least one prioritized cell belonging to the predefined range of band frequency; and when the UE is in the connected mode, sending the measurement report to the wireless network to camp on the at least one prioritized cell belonging to the predefined range of band frequency.

For example, the method comprises suspending the pruning of the measurements of the plurality of cells belonging to the predefined range of band frequency when an ongoing service in the connected mode requires a high bandwidth.

For example, the method comprises camping, by the UE, to the at least one cell from the plurality of cells belonging to a predefined lowest available band frequency based on the trigger condition, when a band priority is defined by an operator.

For example, the UE is configured to use Ultra-Wide Band (UWB), Wireless-Fidelity (Wi-Fi) and Radio Frequency (RF) sensing techniques to detect signal direction, material behind which the UE is, and signal attenuation. The UE is configured to select or prioritize the at least one cell from the plurality of cells belonging to the predefined lowest band frequency from the predefined range of band frequency, based on the signal attenuation.

For example, pruning the measurements of the higher frequency band cells triggers the UE to send UE Assistance Information (UAI) with a maximum number of Carrier Component (CCs) that the UE supports to control unnecessary Carrier Aggression (CA) configurations.

In embodiments, an user equipment (UE) for handling serving a cell selection or a reselection in a wireless network is provided. The method comprises a memory; a communication processor; an input/output (I/O) interface; and a cell selection controller communicatively coupled to the memory, the communication processor and the I/O interface. The cell selection controller is configured to detect a trigger condition to initiate the cell selection or reselection or sending measurement report, wherein the trigger condition indicates that the UE is in one of an idle mode, a connected mode, and an inactive mode; determine a plurality of cells belonging to a predefined range of band frequency for camping the UE; and camp to at least one cell from the plurality of cells belonging to a predefined lowest band frequency based on the trigger condition.

For example, the cell selection controller is further configured to determine whether the trigger condition indicates that the UE is in one of the idle mode, the connected mode, and the inactive mode; perform one of when the UE is in the idle mode, detecting the at least one cell from the plurality of cells belonging to the predefined lowest band frequency from the predefined range of band frequency, selecting the at least one cell belonging to the predefined lowest band frequency within the predefined range of band frequency, and camping to the at least one selected cell belonging to the predefined lowest band frequency; and when the UE is in one of the inactive mode and the connected mode, detecting the at least one cell from the plurality of cells belonging to the predefined lowest band frequency from the predefined range of band frequency, prioritizing the at least one cell belonging to the predefined lowest band frequency within the predefined range of band frequency over the plurality of cells belonging to a predefined highest band frequency and a predefined mid band frequency with in the predefined range of band frequency, wherein the at least one cell belonging to the predefined lowest band frequency is prioritized based on the trigger condition and the plurality of operation parameters of the UE indicated in the trigger condition, and camping to the at least one prioritized cell belonging to the predefined lowest band frequency.

For example, the plurality of operation parameters comprise at least one of a screen status of the UE for a period of time, a power saving mode configuration of the UE, an attenuation level of the cells, a Quality of Service (QOS) level of the UE, an audio status of the UE, a transmitted signal power level of the UE, a path loss level of the UE, a data rate level of the UE, a Random Access Channel (RACH) failure level of the UE, a Block Error Rate (BLER) level of the UE, and a Reference Signal Received Power (RSRP) level of the UE.

For example, the cell selection controller is further configured to categorize the plurality of cells belonging to the predefined range of band frequency into a predefined lowest band frequency, a predefined mid band frequency and a predefined highest band frequency.

For example, the cell selection controller is further configured to receive a reference signal received power (RSRP) for the plurality of cells belonging to the predefined range of band frequency; perform one of pruning measurements of the plurality of cells belonging to the predefined mid band frequency and the predefined highest band frequency within the predefined range of band frequency, and other neighbour cells belonging to the predefined lowest band frequency when the RSRP of the plurality of cells belonging to the predefined range of band frequency is within a first predefined threshold range; pruning the measurements of the plurality of cells belonging to the predefined highest band frequency within the predefined range of band frequency, and the other neighbour cells belonging to the predefined mid band frequency when the RSRP of the plurality of cells belonging to the predefined range of band frequency is within a second predefined threshold range; and pruning the measurements of the other neighbour cells belonging to the predefined highest band frequency when the RSRP of the plurality of cells belonging to the predefined range of band frequency is within a third predefined threshold range.

For example, the cell selection controller is further configured to determine whether the UE is in one of the inactive mode, and the connected mode; perform one of when the UE is in the inactive mode, performing cell reselection to camp on the at least one prioritized cell belonging to the predefined range of band frequency; and when the UE is in the connected mode, sending the measurement report to the wireless network to camp on the at least one prioritized cell belonging to the predefined range of band frequency.

For example, the cell selection controller is further configured to suspend the pruning of the measurements of the plurality of cells belonging to the predefined range of band frequency when an ongoing service in the connected mode requires a high bandwidth.

For example, the cell selection controller is further configured to camp to at least one cell from the plurality of cells belonging to a predefined lowest available band frequency based on the trigger condition, when a band priority is defined by an operator.

For example, the cell selection controller is further configured to use Ultra-Wide Band (UWB), Wireless-Fidelity (Wi-Fi) and Radio Frequency (RF) sensing techniques to detect signal direction, material behind which the UE (201) is, and signal attenuation, and select or prioritize the at least one cell from the plurality of cells belonging to the predefined lowest band frequency from the predefined range of band frequency based on the signal attenuation.

For example, pruning the measurements of the higher frequency band cells triggers the UE to send UE Assistance Information (UAI) with maximum number of Carrier Component (CCs) that the UE supports to control unnecessary Carrier Aggression (CA) configurations.

In embodiments, a method performed by a user equipment (UE) in a wireless network is provided. The method comprises determining whether a trigger condition is detected or not; based on the trigger condition being not detected, selecting a cell among a plurality of cells for the UE in accordance with a signal quality; based on the trigger condition being detected, selecting a cell from at least one cell of low-band frequency category, the plurality of cells categorized into the low-band frequency category, a mid-band frequency category, and high-band frequency category; and camping to the cell or transmitting, on a serving cell, a measurement report including a measurement result of the cell.

For example, the selecting of the cell based on the trigger condition being detected comprises in case that the UE is in one of the inactive mode and the connected mode, detecting the at least one cell of the low-band frequency category; prioritizing the at least one cell of the low-band frequency category over at least one cell of the mid-band frequency range, at least one cell of the high-band frequency range; and selecting the cell based on the at least one prioritized cell.

For example, the at least one cell is prioritized based on the trigger condition and a plurality of operation parameters of the UE indicated in the trigger condition. The plurality of operation parameters comprise at least one of a screen status of the UE for a period of time, a power saving mode configuration of the UE, an attenuation level of the cells, a quality of service (QOS) level of the UE, an audio status of the UE, a transmitted signal power level of the UE, a path loss level of the UE, a data rate level of the UE, a random access channel (RACH) failure level of the UE, a block error rate (BLER) level of the UE, or a reference signal received power (RSRP) level of the UE.

For example, the plurality of cells comprises neighbor cells included in a neighbor cell list configured for the serving cell.

For example, the prioritizing the at least one cell comprises obtaining, by the UE, a reference signal received power (RSRP) of the serving cell; performing, by the UE, one of pruning measurements of at least one cell of the mid-band frequency category, at least one cell of the high-band frequency category, and at least one neighbor cell of the low-band frequency category, in case that the serving cell is in the low-band frequency category and the RSRP of the serving cell is within a first predefined threshold range; pruning the measurements of at least one cell of the high-band frequency category, and at least one neighbor cell in the mid band frequency, in case that the serving cell is in the mid-band frequency category and the RSRP of the serving cell is within a second predefined threshold range; and pruning the measurements of at least one neighbor cell of the high-band frequency category, in case that the serving cell is in the high-band frequency category and the RSRP of the serving cell is within a third predefined threshold range.

For example, the method comprises suspending the pruning of the measurements based on identifying that an ongoing service in the connected mode requires a bandwidth higher than a predefined threshold.

For example, the low-band frequency category corresponds to one or more frequency bands of which frequency is lower than 1 gigahertz (GHz). The mid-band frequency category corresponds to one or more frequency bands of which frequency is higher than 1 GHz and lower than an upper limit of new radio (NR) frequency range 1. The high-band frequency category corresponds to one or more frequency bands of which frequency is within NR frequency range 2.

For example, the determining of whether the trigger condition comprises identifying whether a path loss exceeds a predetermined threshold or not; in case that the path loss exceeds the predetermined threshold, determining that the trigger condition is detected; and in case that the path loss does not exceed the predetermined threshold, determining that the trigger condition is not detected.

For example, the UE is configured to use ultra-wide band (UWB), wireless-fidelity (Wi-Fi) and radio frequency (RF) sensing techniques to detect signal direction, material behind which the UE is, and signal attenuation. In case that the signal attenuation is detected, the trigger condition is detected. In case that the signal attenuation is not detected, the trigger condition is not detected.

For example, the method comprises transmitting, to the base station, UE assistance information (UAI). In case of pruning of measurements of at least one cell of the mid-band frequency category, at least one cell of the high-band frequency category, or at least one neighbor cell of the low-band frequency category, the UAI indicates a support of a single carrier component (CC) to control unnecessary carrier aggression (CA) configurations. In case of no pruning of measurements, the UAI indicates a support of CCs with a maximum number.

In embodiments, a user equipment (UE) in a wireless network is provided. The UE comprises a processor; and a memory storing instructions that, when executed by the processor, cause the UE to determine whether a trigger condition is detected or not; based on the trigger condition being not detected, select a cell among a plurality of cells for the UE in accordance with a signal quality; based on the trigger condition being detected, select a cell from at least one cell of low-band frequency category, the plurality of cells categorized into the low-band frequency category, a mid-band frequency category, and high-band frequency category; and camp to the cell or transmit, on a serving cell, a measurement report including a measurement result of the cell.

For example, the instructions, when executed by the processor, cause the UE to in case that the UE is in one of the inactive mode and the connected mode, detect the at least one cell of the low-band frequency category; prioritize the at least one cell of the low-band frequency category over at least one cell of the mid-band frequency range, at least one cell of the high-band frequency range; and select the cell based on the at least one prioritized cell.

For example, the at least one cell is prioritized based on the trigger condition and a plurality of operation parameters of the UE indicated in the trigger condition. The plurality of operation parameters comprise at least one of a screen status of the UE for a period of time, a power saving mode configuration of the UE, an attenuation level of the cells, a quality of service (QOS) level of the UE, an audio status of the UE, a transmitted signal power level of the UE, a path loss level of the UE, a data rate level of the UE, a random access channel (RACH) failure level of the UE, a block error rate (BLER) level of the UE, or a reference signal received power (RSRP) level of the UE.

For example, the plurality of cells comprises neighbor cells included in a neighbor cell list configured for the serving cell.

For example, the instructions, when executed by the processor, cause the UE to obtain a reference signal received power (RSRP) of the serving cell; perform one of pruning measurements of at least one cell of the mid-band frequency category, at least one cell of the high-band frequency category, and at least one neighbor cell of the low-band frequency category, in case that the serving cell is in the low-band frequency category and the RSRP of the serving cell is within a first predefined threshold range; pruning the measurements of at least one cell of the high-band frequency category, and at least one neighbor cell in the mid band frequency, in case that the serving cell is in the mid-band frequency category and the RSRP of the serving cell is within a second predefined threshold range; and pruning the measurements of at least one neighbor cell of the high-band frequency category, in case that the serving cell is in the high-band frequency category and the RSRP of the serving cell is within a third predefined threshold range.

For example, the instructions, when executed by the processor, cause the UE to suspend the pruning of the measurements based on identifying that an ongoing service in the connected mode requires a bandwidth higher than a predefined threshold.

For example, the low-band frequency category corresponds to one or more frequency bands of which frequency is lower than 1 gigahertz (GHz). The mid-band frequency category corresponds to one or more frequency bands of which frequency is higher than 1 GHz and lower than an upper limit of new radio (NR) frequency range 1. The high-band frequency category corresponds to one or more frequency bands of which frequency is within NR frequency range 2.

For example, the instructions, when executed by the processor, cause the UE to identify whether a path loss exceeds a predetermined threshold or not; in case that the path loss exceeds the predetermined threshold, determine that the trigger condition is detected; and in case that the path loss does not exceed the predetermined threshold, determine that the trigger condition is not detected.

For example, the UE is configured to use ultra-wide band (UWB), wireless-fidelity (Wi-Fi) and radio frequency (RF) sensing techniques to detect signal direction, material behind which the UE is, and signal attenuation. In case that the signal attenuation is detected, the trigger condition is detected. In case that the signal attenuation is not detected, the trigger condition is not detected.

For example, the instructions, when executed by the processor, cause the UE to transmit, to the base station, UE assistance information (UAI). In case of pruning of measurements of at least one cell of the mid-band frequency category, at least one cell of the high-band frequency category, or at least one neighbor cell of the low-band frequency category, the UAI indicates a support of a single carrier component (CC) to control unnecessary carrier aggression (CA) configurations. In case of no pruning of measurements, the UAI indicates a support of CCs with a maximum number.

In embodiments, a non-transitory computer readable storage medium is provided. The non-transitory computer readable storage medium stores instructions that, when executed by a processor, cause a user equipment (UE) to perform operations including determining whether a trigger condition is detected or not; based on the trigger condition being not detected, selecting a cell among a plurality of cells for the UE in accordance with a signal quality; based on the trigger condition being detected, selecting a cell from at least one cell of low-band frequency category, the plurality of cells categorized into the low-band frequency category, a mid-band frequency category, and high-band frequency category; and camping to the cell or transmitting, on a serving cell, a measurement report including a measurement result of the cell.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method performed by a user equipment (UE) in a wireless network, comprising:
determining whether a trigger condition is detected or not;
based on the trigger condition being not detected, selecting a cell among a plurality of cells for the UE in accordance with a signal quality;
based on the trigger condition being detected, selecting a cell from at least one cell of low-band frequency category, the plurality of cells categorized into the low-band frequency category, a mid-band frequency category, and high-band frequency category; and
camping to the cell or transmitting, on a serving cell, a measurement report including a measurement result of the cell.

2. The method of claim 1, wherein the selecting of the cell based on the trigger condition being detected comprises:
in case that the UE is in one of the inactive mode and the connected mode, detecting the at least one cell of the low-band frequency category;
prioritizing the at least one cell of the low-band frequency category over at least one cell of the mid-band frequency range, at least one cell of the high-band frequency range; and
selecting the cell based on the at least one prioritized cell.

3. The method of claim 2, wherein the at least one cell is prioritized based on the trigger condition and a plurality of operation parameters of the UE indicated in the trigger condition, and
wherein the plurality of operation parameters comprise at least one of a screen status of the UE for a period of time, a power saving mode configuration of the UE, an attenuation level of the cells, a quality of service (QOS) level of the UE, an audio status of the UE, a transmitted signal power level of the UE, a path loss level of the UE, a data rate level of the UE, a random access channel (RACH) failure level of the UE, a block error rate (BLER) level of the UE, or a reference signal received power (RSRP) level of the UE.

4. The method of claim 2, wherein the plurality of cells comprises neighbor cells included in a neighbor cell list configured for the serving cell.

5. The method of claim 2, wherein the prioritizing the at least one cell comprises:
obtaining, by the UE, a reference signal received power (RSRP) of the serving cell;
performing, by the UE, one of:
pruning measurements of at least one cell of the mid-band frequency category, at least one cell of the high-band frequency category, and at least one neighbor cell of the low-band frequency category, in case that the serving cell is in the low-band frequency category and the RSRP of the serving cell is within a first predefined threshold range;
pruning the measurements of at least one cell of the high-band frequency category, and at least one neighbor cell in the mid band frequency, in case that the serving cell is in the mid-band frequency category and the RSRP of the serving cell is within a second predefined threshold range; and
pruning the measurements of at least one neighbor cell of the high-band frequency category, in case that the serving cell is in the high-band frequency category and the RSRP of the serving cell is within a third predefined threshold range.

6. The method of claim 5, further comprising:
suspending the pruning of the measurements based on identifying that an ongoing service in the connected mode requires a bandwidth higher than a predefined threshold.

7. The method of claim 1, wherein the low-band frequency category corresponds to one or more frequency bands of which frequency is lower than 1 gigahertz (GHz),
wherein the mid-band frequency category corresponds to one or more frequency bands of which frequency is higher than 1 GHz and lower than an upper limit of new radio (NR) frequency range 1, and
wherein the high-band frequency category corresponds to one or more frequency bands of which frequency is within NR frequency range 2.

8. The method of claim 1, wherein the determining of whether the trigger condition comprises:
identifying whether a path loss exceeds a predetermined threshold or not;
in case that the path loss exceeds the predetermined threshold, determining that the trigger condition is detected; and
in case that the path loss does not exceed the predetermined threshold, determining that the trigger condition is not detected.

9. The method of claim 1, wherein the UE is configured to use ultra-wide band (UWB), wireless-fidelity (Wi-Fi) and radio frequency (RF) sensing techniques to detect signal direction, material behind which the UE is, and signal attenuation,
wherein, in case that the signal attenuation is detected, the trigger condition is detected; and
wherein, in case that the signal attenuation is not detected, the trigger condition is not detected.

10. The method of claim 1, further comprising:
transmitting, to the base station, UE assistance information (UAI),
wherein, in case of pruning of measurements of at least one cell of the mid-band frequency category, at least one cell of the high-band frequency category, or at least one neighbor cell of the low-band frequency category, the UAI indicates a support of a single carrier component (CC) to control unnecessary carrier aggression (CA) configurations, and
wherein, in case of no pruning of measurements, the UAI indicates a support of CCs with a maximum number.

11. A user equipment (UE) in a wireless network, the UE comprising:
a processor; and
a memory storing instructions that, when executed by the processor, cause the UE to:
determine whether a trigger condition is detected or not;
based on the trigger condition being not detected, select a cell among a plurality of cells for the UE in accordance with a signal quality;
based on the trigger condition being detected, select a cell from at least one cell of low-band frequency category, the plurality of cells categorized into the low-band frequency category, a mid-band frequency category, and high-band frequency category; and
camp to the cell or transmit, on a serving cell, a measurement report including a measurement result of the cell.

12. The UE of claim 11, wherein the instructions, when executed by the processor, cause the UE to:
in case that the UE is in one of the inactive mode and the connected mode, detect the at least one cell of the low-band frequency category;
prioritize the at least one cell of the low-band frequency category over at least one cell of the mid-band frequency range, at least one cell of the high-band frequency range; and
select the cell based on the at least one prioritized cell.

13. The UE of claim 12, wherein the at least one cell is prioritized based on the trigger condition and a plurality of operation parameters of the UE indicated in the trigger condition, and
wherein the plurality of operation parameters comprise at least one of a screen status of the UE for a period of time, a power saving mode configuration of the UE, an attenuation level of the cells, a quality of service (QOS) level of the UE, an audio status of the UE, a transmitted signal power level of the UE, a path loss level of the UE, a data rate level of the UE, a random access channel (RACH) failure level of the UE, a block error rate (BLER) level of the UE, or a reference signal received power (RSRP) level of the UE.

14. The UE of claim 12, wherein the plurality of cells comprises neighbor cells included in a neighbor cell list configured for the serving cell.

15. The UE of claim 12, wherein the instructions, when executed by the processor, cause the UE to:
obtain a reference signal received power (RSRP) of the serving cell;
perform one of:
pruning measurements of at least one cell of the mid-band frequency category, at least one cell of the high-band frequency category, and at least one neighbor cell of the low-band frequency category, in case that the serving cell is in the low-band frequency category and the RSRP of the serving cell is within a first predefined threshold range;
pruning the measurements of at least one cell of the high-band frequency category, and at least one neighbor cell in the mid band frequency, in case that the serving cell is in the mid-band frequency category and the RSRP of the serving cell is within a second predefined threshold range; and
pruning the measurements of at least one neighbor cell of the high-band frequency category, in case that the serving cell is in the high-band frequency category and the RSRP of the serving cell is within a third predefined threshold range.

16. The UE of claim 15, wherein the instructions, when executed by the processor, cause the UE to:
suspend the pruning of the measurements based on identifying that an ongoing service in the connected mode requires a bandwidth higher than a predefined threshold.

17. The UE of claim 11, wherein the low-band frequency category corresponds to one or more frequency bands of which frequency is lower than 1 gigahertz (GHz),
wherein the mid-band frequency category corresponds to one or more frequency bands of which frequency is higher than 1 GHz and lower than an upper limit of new radio (NR) frequency range 1, and
wherein the high-band frequency category corresponds to one or more frequency bands of which frequency is within NR frequency range 2.

18. The UE of claim 11, wherein the instructions, when executed by the processor, cause the UE to:
identify whether a path loss exceeds a predetermined threshold or not;
in case that the path loss exceeds the predetermined threshold, determine that the trigger condition is detected; and
in case that the path loss does not exceed the predetermined threshold, determine that the trigger condition is not detected.

19. The UE of claim 11, wherein the UE is configured to use ultra-wide band (UWB), wireless-fidelity (Wi-Fi) and radio frequency (RF) sensing techniques to detect signal direction, material behind which the UE is, and signal attenuation,
wherein, in case that the signal attenuation is detected, the trigger condition is detected; and
wherein, in case that the signal attenuation is not detected, the trigger condition is not detected.

20. A non-transitory computer readable storage medium storing instructions that, when executed by a processor, cause a user equipment (UE) to perform operations including:
determining whether a trigger condition is detected or not;
based on the trigger condition being not detected, selecting a cell among a plurality of cells for the UE in accordance with a signal quality; based on the trigger condition being detected,
selecting a cell from at least one cell of low-band frequency category, the plurality of cells categorized into the low-band frequency category, a mid-band frequency category, and high-band frequency category; and
camping to the cell or transmitting, on a serving cell, a measurement report including a measurement result of the cell.
